(19) United States
(12) Patent Application Publication
(10) Pub. No.: US 2026/0080885 A1
(43) Pub. Date: Mar. 19, 2026

(54) SPEECH AND NOISE DISENTANGLEMENT FOR ACOUSTIC ECHO CANCELLATION

(71) Applicant: Nokia Technologies Oy, Espoo (FI)

(72) Inventors: Konstantinos DROSOS, Espoo (FI); Mikko Olavi HEIKKINEN, Tampere (FI); Sampo VESA, Espoo (FI); Miikka Tapani VILERMO, Tampere (FI)

(21) Appl. No.: 19/311,545

(22) Filed: Aug. 27, 2025

(30) Foreign Application Priority Data
Sep. 17, 2024 (FI) 20246133

(51) Int. Cl. G10L 21/0216; G10L 21/0208; G10L 25/30

(52) U.S. Cl. CPC G10L 21/0216; G10L 25/30; G10L 2021/02082

(57) ABSTRACT

The present disclosure relates to an apparatus, that obtains a far-end signal and a near-end microphone signal, determines, based on at least the far-end signal, a far-end speech signal estimate and a far-end noise signal estimate, determines, based on at least the near-end microphone signal, a near-end microphone speech signal estimate and a near-end microphone noise signal estimate, determines, based on at least the far-end speech signal estimate and the near-end microphone speech signal estimate, a predicted near-end speech signal, determines, based on at least the far-end noise signal estimate and the near-end microphone noise signal estimate, a predicted near-end noise signal and outputs at least the predicted near-end speech signal and predicted near-end noise signal.

### TECHNICAL FIELD

Various example embodiments described herein relate to the field of digital signal processing, and more particularly to acoustic echo cancellation within audio communication.

### BACKGROUND

Acoustic echo cancellation (AEC) may be understood as various techniques used to improve audio quality within audio communication by removing/reducing effects of a received far-end signal, reproduced by, e.g., a near-end speaker, from a captured signal captured at near-end by, e.g., a near-end microphone. Residual echo suppression (RES) may be understood as techniques used to suppress remaining echo after using an AEC technique. In the context of this specification RES may be understood to be a part of an AEC process. These techniques may require simultaneous source separation/denoising and speech diarization, which may present challenges for signal processing capacity. Audio communication may also have a disadvantage of not capturing ambience and/or noise for transmitted signal, which may result in, e.g., preventing immersing oneself in surrounding sounds or even noticing an absence of signal during pauses in speech.

Thus, an AEC process enabling factorization of simultaneous tasks of source separation/denoising and speech diarization into separate consecutive tasks may be beneficial for enhancing model training efficiency. Enabling also transmitting ambience and/or noise may be beneficial for improving and enhancing quality of communication.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments of the present disclosure enable an improved acoustic echo cancellation process. This benefit may be achieved by the features of the independent claims. Further example embodiments are provided in the dependent claims, the detailed description, and the drawings.

According to a first aspect, an apparatus is disclosed. The apparatus may comprise at least one processor and at least one memory storing instructions that, when executed by the at least one processor, cause the apparatus to at least: Obtain a far-end signal, the far-end signal being based on at least one far-end speech source and at least one far-end noise source. Obtain a near-end microphone signal captured by a near-end microphone, the near-end microphone signal being based on at least one near-end speech source, at least one near-end noise source, and an altered far-end signal. Determine, based on at least the far-end signal, a far-end speech signal estimate and a far-end noise signal estimate. Determine, based on at least the near-end microphone signal, a near-end microphone speech signal estimate and a near-end microphone noise signal estimate. Determine, based on at least the far-end speech signal estimate and the near-end microphone speech signal estimate, a predicted near-end speech signal by attenuating an impact of the at least one far-end speech source from the near-end microphone speech signal estimate. Determine, based on at least the far-end noise signal estimate and the near-end microphone noise signal estimate, a predicted near-end noise signal by attenuating an impact of the at least one far-end noise source from the near-end microphone noise signal estimate. Output at least the predicted near-end speech signal and predicted near-end noise signal.

Such an apparatus may enhance model training efficiency by enabling factorization of an acoustic echo cancellation process. Enabling transmitting predicted ambience and/or noise signals with predicted speech signals separately or combined may improve and/or enhance quality of communication.

According to an example embodiment of the first aspect, the determining the far-end speech signal estimate and the far-end noise signal estimate may further comprise use of a first trained source separation model or a first trained denoising model. Such an apparatus may enable efficient model training.

According to an example embodiment of the first aspect, the first trained source separation model may be a first trained source separation deep neural network. The determining the far-end speech signal estimate and the far-end noise signal estimate may further cause the apparatus to: Determine, based on the far-end signal, using the first trained source separation deep neural network, a first source separation mask. Determine the far-end speech signal estimate by element-wise product between the first source separation mask and the far-end signal. Determine the far-end noise signal estimate by subtracting the far-end speech signal estimate from the far-end signal. Such an apparatus may enable efficient deep neural network training.

According to an example embodiment of the first aspect, the first trained denoising model may be a first trained denoising deep neural network. The determining the far-end speech signal estimate and the far-end noise signal estimate may further cause the apparatus to: Determine, based on the far-end signal, using the first trained denoising deep neural network, a first denoising mask. Determine the far-end speech signal estimate by element-wise product between the first denoising mask and the far-end signal. Determine the far-end noise signal estimate by subtracting the far-end speech signal estimate from the far-end signal. Such an apparatus may enable efficient deep neural network training.

According to an example embodiment of the first aspect, the determining of the near-end microphone speech signal estimate and the near-end microphone noise signal estimate may further comprise use of a second trained source separation model or a second trained denoising model. Such an apparatus may enable efficient model training.

According to an example embodiment of the first aspect, the second trained source separation model may be a second trained source separation deep neural network. The determining the near-end microphone speech signal estimate and the near-end microphone noise signal estimate may further cause the apparatus to: Determine, based on the near-end microphone signal, using the second trained source separation deep neural network, a second source separation mask. Determine the near-end microphone speech signal estimate by element-wise product between the second source separation mask and the near-end microphone signal. Determine the near-end microphone noise signal estimate by subtracting the near-end microphone speech signal estimate from the near-end microphone signal. Such an apparatus may enable efficient deep neural network training and enhanced audio communication.

According to an example embodiment of the first aspect, the second trained source separation deep neural network may be the first trained source separation deep neural network. Such an apparatus may enable expeditious deep neural network training.

According to an example embodiment of the first aspect, the second trained denoising model may be a second trained denoising deep neural network. The determining the near-end microphone speech signal estimate and the near-end microphone noise signal estimate may further cause the apparatus to: Determine, based on the near-end microphone signal, using the second trained denoising deep neural network, a second denoising mask. Determine the near-end microphone speech signal estimate by element-wise product between the second denoising mask and the near-end microphone signal. Determine the near-end microphone noise signal estimate by subtracting the near-end microphone speech signal estimate from the near-end microphone signal. Such an apparatus may enable efficient deep neural network training and enhanced audio communication.

According to an example embodiment of the first aspect, the second trained denoising deep neural network may be the first trained denoising deep neural network. Such an apparatus may enable expeditious deep neural network training.

According to an example embodiment of the first aspect, the determining of the predicted speech signal may further comprise use of a first trained conditioned diarization model. The determining of the predicted noise signal may further comprise use of a second trained conditioned diarization model. Such an apparatus may enable efficient diarization model training.

According to an example embodiment of the first aspect, the first trained conditioned diarization model may be a first trained conditioned diarization deep neural network. The determining the predicted near-end speech signal may further cause the apparatus to: Determine, based on the near-end microphone speech signal estimate and the far-end speech signal estimate, using the first trained conditioned diarization deep neural network, a first diarization mask. Determine the predicted near-end speech signal by an element-wise product between the first diarization mask and the near-end microphone speech signal estimate. Such an apparatus may enable efficient deep neural network training and enhanced audio communication.

According to an example embodiment of the first aspect, the second trained conditioned diarization model may be a second trained conditioned diarization deep neural network. The determining the predicted near-end noise signal may further cause the apparatus to: Determine, based on the near-end microphone noise signal estimate and the far-end noise signal estimate, using the second trained conditioned diarization deep neural network, a second diarization mask. Determine the predicted near-end noise signal by an element-wise product between the second diarization mask and the near-end microphone noise signal estimate. Such an apparatus may enable efficient deep neural network training and enhanced audio communication.

According to an example embodiment of the first aspect, the second trained conditioned diarization deep neural network may be the first trained conditioned diarization deep neural network. Such an apparatus may enable expeditious deep neural network training.

According to an example embodiment of the first aspect, the altered far-end signal may comprise the far-end signal reproduced by at least one near-end speaker and altered by near-end environment acoustics.

According to an example embodiment of the first aspect, the far-end signal may be captured by a far-end microphone.

According to a second aspect, a method is disclosed. The method may be computer-implemented. The method may comprise: Obtaining a far-end signal, the far-end signal being based on at least one far-end speech source and at least one far-end noise source. Obtaining a near-end microphone signal captured by a near-end microphone, the near-end microphone signal being based on at least one near-end speech source, at least one near-end noise source, and an altered far-end signal. Determining, based on at least the far-end signal, a far-end speech signal estimate and a far-end noise signal estimate. Determining, based on at least the near-end microphone signal, a near-end microphone speech signal estimate and a near-end microphone noise signal estimate. Determining, based on at least the far-end speech signal estimate and the near-end microphone speech signal estimate, a predicted near-end speech signal by attenuating an impact of the at least one far-end speech source from the near-end microphone speech signal estimate. Determining, based on at least the far-end noise signal estimate and the near-end microphone noise signal estimate, a predicted near-end noise signal by attenuating an impact of the at least one far-end noise source from the near-end microphone noise signal estimate. Outputting at least the predicted near-end speech signal and predicted near-end noise signal. Such a method may enhance model training efficiency by enabling factorization of an acoustic echo cancellation process. Enabling transmitting predicted ambience and/or noise signals with predicted speech signals separately or combined may improve and/or enhance quality of communication.

According to an example embodiment of the second aspect, the determining the far-end speech signal estimate and the far-end noise signal estimate may further comprise use of a first trained source separation model or a first trained denoising model. Such a method may enable efficient model training.

According to an example embodiment of the second aspect, the first trained source separation model may be a first trained source separation deep neural network. The determining the far-end speech signal estimate and the far-end noise signal estimate may further comprise: Determining, based on the far-end signal, using the first trained source separation deep neural network, a first source separation mask. Determining the far-end speech signal estimate by element-wise product between the first source separation mask and the far-end signal. Determining the far-end noise signal estimate by subtracting the far-end speech signal estimate from the far-end signal. Such a method may enable efficient deep neural network training.

According to an example embodiment of the second aspect, the first trained denoising model may be a first trained denoising deep neural network. The determining the far-end speech signal estimate and the far-end noise signal estimate may further comprise: Determining, based on the far-end signal, using the first trained denoising deep neural network, a first denoising mask. Determining the far-end speech signal estimate by element-wise product between the first denoising mask and the far-end signal. Determining the far-end noise signal estimate by subtracting the far-end speech signal estimate from the far-end signal. Such a method may enable efficient deep neural network training.

According to an example embodiment of the second aspect, the determining of the near-end microphone speech signal estimate and the near-end microphone noise signal estimate may further comprise use of a second trained source separation model or a second trained denoising model. Such a method may enable efficient model training.

According to an example embodiment of the second aspect, the second trained source separation model may be a second trained source separation deep neural network. The determining the near-end microphone speech signal estimate and the near-end microphone noise signal estimate may further comprise: Determining, based on the near-end microphone signal, using the second trained source separation deep neural network, a second source separation mask. Determining the near-end microphone speech signal estimate by element-wise product between the second source separation mask and the near-end microphone signal. Determining the near-end microphone noise signal estimate by subtracting the near-end microphone speech signal estimate from the near-end microphone signal. Such a method may enable efficient deep neural network training and enhanced audio communication.

According to an example embodiment of the second aspect, the second trained source separation deep neural network may be the first trained source separation deep neural network. Such a method may enable expeditious deep neural network training.

According to an example embodiment of the second aspect, the second trained denoising model may be a second trained denoising deep neural network. The determining the near-end microphone speech signal estimate and the near-end microphone noise signal estimate may further comprise: Determining, based on the near-end microphone signal, using the second trained denoising deep neural network, a second denoising mask. Determining the near-end microphone speech signal estimate by element-wise product between the second denoising mask and the near-end microphone signal. Determining the near-end microphone noise signal estimate by subtracting the near-end microphone speech signal estimate from the near-end microphone signal. Such a method may enable efficient deep neural network training and enhanced audio communication.

According to an example embodiment of the second aspect, the second trained denoising deep neural network may be the first trained denoising deep neural network. Such a method may enable expeditious deep neural network training.

According to an example embodiment of the second aspect, the determining of the predicted speech signal may further comprise use of a first trained conditioned diarization model. The determining of the predicted noise signal may further comprise use of a second trained conditioned diarization model. Such a method may enable efficient diarization model training.

According to an example embodiment of the second aspect, the first trained conditioned diarization model may be a first trained conditioned diarization deep neural network. The determining the predicted near-end speech signal may further comprise: Determining, based on the near-end microphone speech signal estimate and the far-end speech signal estimate, using the first trained conditioned diarization deep neural network, a first diarization mask. Determining the predicted near-end speech signal by an element-wise product between the first diarization mask and the near-end microphone speech signal estimate. Such a method may enable efficient deep neural network training and enhanced audio communication.

According to an example embodiment of the second aspect, the second trained conditioned diarization model may be a second trained conditioned diarization deep neural network. The determining the predicted near-end noise signal may further comprise: Determining, based on the near-end microphone noise signal estimate and the far-end noise signal estimate, using the second trained conditioned diarization deep neural network, a second diarization mask. Determining the predicted near-end noise signal by an element-wise product between the second diarization mask and the near-end microphone noise signal estimate. Such a method may enable efficient deep neural network training and enhanced audio communication.

According to an example embodiment of the second aspect, the second trained conditioned diarization deep neural network may be the first trained conditioned diarization deep neural network. Such a method may enable expeditious deep neural network training.

According to an example embodiment of the second aspect, the altered far-end signal may comprise the far-end signal reproduced by at least one near-end speaker and altered by near-end environment acoustics.

According to an example embodiment of the second aspect, the far-end signal may be captured by a far-end microphone.

According to a third aspect, a computer-readable medium is disclosed. The computer-readable medium may comprise program instructions for causing an apparatus at least to: Obtain a far-end signal, the far-end signal being based on at least one far-end speech source and at least one far-end noise source. Obtain a near-end microphone signal captured by a near-end microphone, the near-end microphone signal being based on at least one near-end speech source, at least one near-end noise source, and an altered far-end signal. Determine, based on at least the far-end signal, a far-end speech signal estimate and a far-end noise signal estimate. Determine, based on at least the near-end microphone signal, a near-end microphone speech signal estimate and a near-end microphone noise signal estimate. Determine, based on at least the far-end speech signal estimate and the near-end microphone speech signal estimate, a predicted near-end speech signal by attenuating an impact of the at least one far-end speech source from the near-end microphone speech signal estimate. Determine, based on at least the far-end noise signal estimate and the near-end microphone noise signal estimate, a predicted near-end noise signal by attenuating an impact of the at least one far-end noise source from the near-end microphone noise signal estimate. Output at least the predicted near-end speech signal and predicted near-end noise signal.

According to a fourth aspect, a computer program is disclosed. The computer program may comprise instructions for causing an apparatus at least to: Obtain a far-end signal, the far-end signal being based on at least one far-end speech source and at least one far-end noise source. Obtain a near-end microphone signal captured by a near-end microphone, the near-end microphone signal being based on at least one near-end speech source, at least one near-end noise source, and an altered far-end signal. Determine, based on at least the far-end signal, a far-end speech signal estimate and a far-end noise signal estimate. Determine, based on at least the near-end microphone signal, a near-end microphone speech signal estimate and a near-end microphone noise signal estimate. Determine, based on at least the far-end speech signal estimate and the near-end microphone speech signal estimate, a predicted near-end speech signal by attenuating an impact of the at least one far-end speech source from the near-end microphone speech signal estimate. Determine, based on at least the far-end noise signal estimate and the near-end microphone noise signal estimate, a predicted near-end noise signal by attenuating an impact of the at least one far-end noise source from the near-end microphone noise signal estimate. Output at least the predicted near-end speech signal and predicted near-end noise signal.

Any example embodiment may be combined with one or more other example embodiments. Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates a general exemplary architecture of a communication system;

FIG. 2 illustrates an example functionality of an apparatus according to an example embodiment;

FIG. 3 illustrates an example signaling diagram within an example functionality of an apparatus according to an example embodiment;

FIG. 4 illustrates an example signaling diagram within an example functionality of an apparatus according to an example embodiment;

FIG. 5 illustrates an example signaling diagram within an example functionality of an apparatus according to an example embodiment;

FIG. 6 illustrates an example functionality of an apparatus according to an example embodiment;

FIG. 7 illustrates an example functionality of an apparatus according to an example embodiment;

FIG. 8 illustrates an example functionality of an apparatus according to an example embodiment;

FIG. 9 illustrates an example functionality of an apparatus according to an example embodiment;

FIG. 10 illustrates an example functionality of an apparatus according to an example embodiment;

FIG. 11 illustrates an example functionality of an apparatus according to an example embodiment;

FIG. 12 illustrates an example training process for an example functionality of an apparatus according to an example embodiment; and

FIG. 13 illustrates a schematic block diagram of an apparatus according to an example embodiment.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the specification may refer to “an”, “one”, or “some” embodiment(s) in several locations, this does not necessarily mean that each such reference is to the same embodiment(s), or that the feature may not apply to other embodiments. Single features of different embodiments may also be combined to provide other embodiments. Furthermore, words “comprising” and “including” should be understood as not limiting the described embodiments/examples to consist of only those features that have been mentioned and such embodiments/examples may contain also features/structures that have not been specifically mentioned.

Furthermore, although the numerative terminology, such as “first”, “second”, etc., may be used herein to describe various embodiments, elements, or features, it should be understood that these embodiments, elements, or features should not be limited by this numerative terminology. This numerative terminology is used herein only to distinguish one embodiment, element, or feature from another embodiment, element, or feature. For example, a first trained denoising model discussed below could be called a second trained denoising model, and vice versa, without departing from the teachings of the present disclosure.

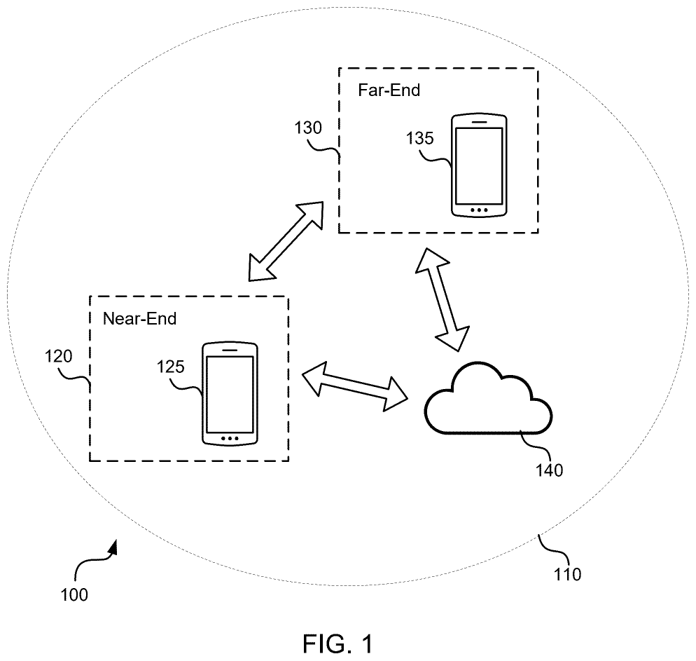

FIG. 1 depicts a general exemplary architecture of a communication system 100 where various embodiments of the present disclosure may be implemented. FIG. 1 is a simplified system architecture showing only some devices, apparatuses, elements and functional entities, all being logical units, whose implementation and/or number may differ from what is shown. The connections shown in FIG. 1 are logical connections: the actual physical connections may be different. It is apparent to a person skilled in the art that the system comprises any number of shown elements, other equipment, other functions, and other structures that are not shown. They, as well as the protocols used, are well known by persons skilled in the art and are irrelevant to the actual disclosure. Therefore, they need not be discussed in more detail here. The embodiments are not, however, restricted to the system given as an example but a person skilled in the art may apply the solution to other communication systems provided with necessary properties.

The system 100 may comprise one or more cellular communication protocols 110 such as, e.g., a fifth generation (5G) or sixth generation (6G) net-work or a network beyond 6G wireless networks. The embodiments may also be applied to other kinds of communications networks 110 having suitable means by adjusting parameters and procedures appropriately. Some examples of other options for suitable systems are a universal mobile telecommunications system (UMTS) radio access network (UTRAN or E-UTRAN), long term evolution (LTE, E-UTRA) or the like, short range wireless communication network, such as wireless local area network (WLAN or WiFi), worldwide interoperability for microwave access (WiMAX), Bluetooth®, personal communications services (PCS), ZigBee®, systems using ultra-wideband (UWB) technology, sensor networks or the like, wideband code division multiple access (WCDMA), mobile ad-hoc networks (MANETs) and Internet Protocol multimedia subsystems (IMS) or any combination thereof. Further, the system may comprise alternatively or additionally a wired or fiber optic communication network 110. An example representation of system 100 is shown depicting a user device 125 and a user device 135 communicating with each other, e.g., to provide audio communication, for example, a spatial audio communication and/or teleconferencing service. The user device 125 is in a first location 120 (e.g., a first room or a first city) and the user device 135 is in a second location 130 (e.g., a second room or a second city). Since the disclosure is, in a manner, from the point of view of the user device 125, the first location 120 may be referred to as a near-end, and the second location 130 may be referred to as a far-end. The system 100 may further comprise one or more clouds or cloud elements 140, such as cloud services, cloud servers, or cloud platforms (only one illustrated in FIG. 1) or any combination thereof, which are connected over the one or more networks 110 to the user devices 125, 135.

The system 100 comprises at least a processing circuitry (processor) configured to analyze and process audio signals, e.g., by carrying out functionalities described in more detail below. The processing circuitry may be realized in the user device 125, 135 or in the one or more clouds 140.

The user device 125, 135 may refer to a device (e.g. a portable or non-portable computing device) that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, multimedia device, a smart audio headset, a smart watch, an augmented reality (AR) device, a virtual reality (VR) device, an extended reality (XR) device, a television, a vehicle infotainment unit, or any combination thereof. In some applications, the user device 125, 135 may comprise or may be connected to a user portable device with radio parts (such as a watch, earphones, eyeglasses, other wearable accessories or wearables). The user device 125, 135 may be configured to perform one or more of user equipment functionalities or the user device 125, 135 may also utilize cloud and computation may be fully or partly performed in the cloud 140. The user device 125, 135 may also be called a subscriber unit, mobile station, remote terminal, access terminal, user terminal, or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT (Information and Communication technology) devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

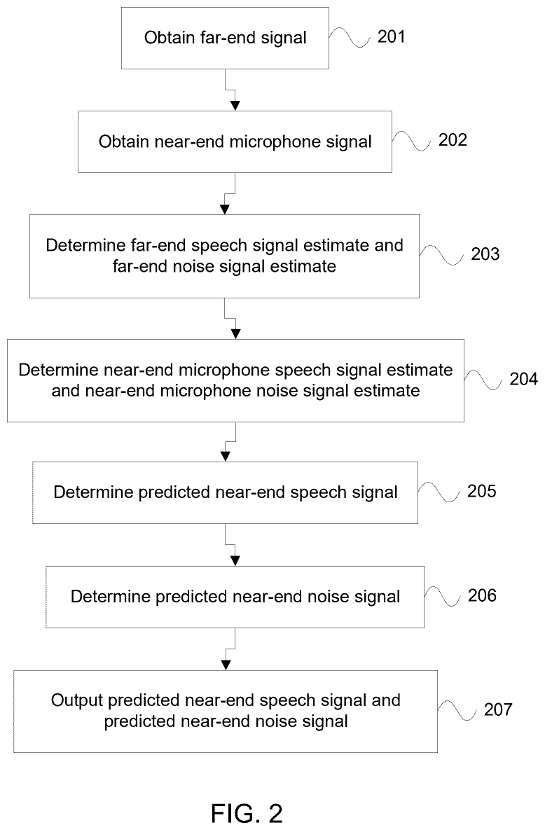

An apparatus configured to perform audio echo cancellation may be configured to disentangle speech and noise/ambience, e.g., as described below with FIGS. 2 to 11.

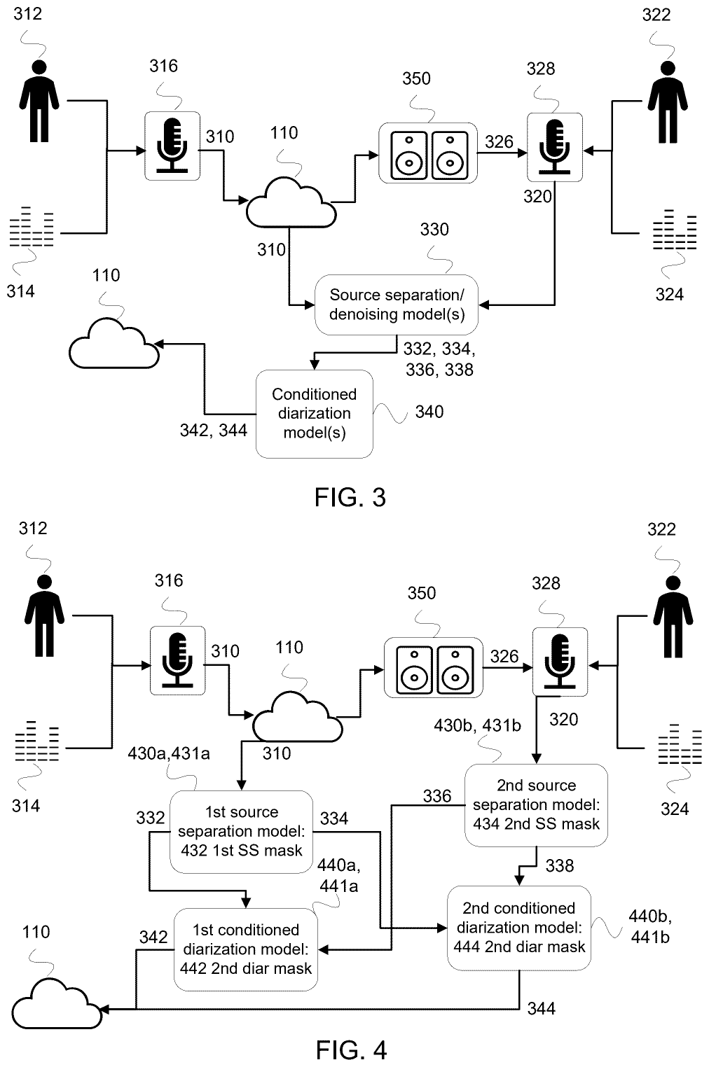

FIG. 2 illustrates an example functionality of an apparatus, such as the user device 125, 135 and/or the cloud element 140, configured to perform acoustic echo cancellation (AEC) and residual echo suppression (RES) according to an example embodiment. FIG. 3 is a diagram illustrating signals obtained, determined, and output within the example functionality. In the context of this specification, the term ‘signal estimate’ may be understood as a signal determined or generated to approximate or predict such a signal that may not be captured as such due to, e.g., noise, microphone ambient components, and/or environment acoustics. In the context of this specification, the term ‘trained model’ may be understood as the model having been pre-trained or learned with a training data set to generate, e.g., a source separation/denoising mask or a conditioned diarization mask for input data.

Referring to FIG. 2 and FIG. 3, a far-end signal s_{f} 310 is obtained at operation 201. The far-end signal is based on at least one far-end speech source 312 (generating a far-end speech signal x_{f}) and at least one far-end noise source 314 (generating a far-end noise signal η_{f}). In an example embodiment, the far-end signal 310 is captured by a far-end microphone 316. A near-end microphone signal s_{fn} 320 is obtained at operation 202. The near-end microphone signal 320 is captured by a near-end microphone 328. The near-end microphone signal is based on at least one near-end speech source 322 (generating a near-end speech signal xₙ), at least one near-end noise source 324 (generating a near-end noise signal ηₙ), and an altered far-end signal \tilde{s}_{f} 326. The near-end microphone signal may be understood to be a linear combination of signals, which may be formulated as s_{fn}=sₙ+\tilde{s}_{f}=xₙ+ηₙ+\tilde{s}_{f}. In an example embodiment, the altered far-end signal 326 comprises the far-end signal 310, reproduced by at least one near-end speaker 350 and possibly altered by near-end environment acoustics, such as, e.g., room acoustics.

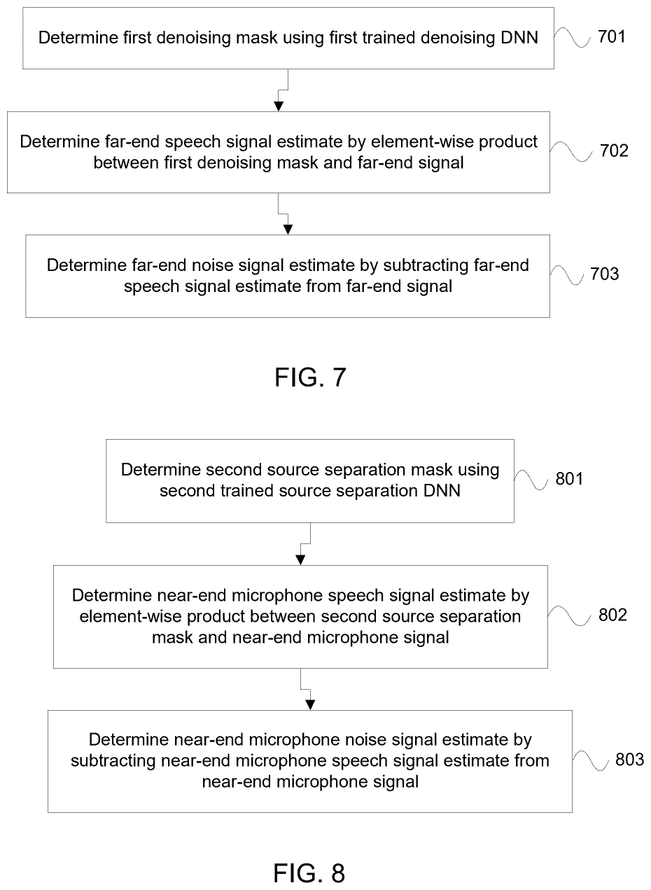

Referring to FIG. 2 and FIG. 3, a far-end speech signal estimate \hat{x}_{f} 332 and a far-end noise signal estimate \hat{η}_{f} 334 are determined at operation 203, based on at least the far-end signal 310. In an example embodiment, the determining the far-end speech signal estimate 332 and the far-end noise signal estimate 334 further comprises use of a first trained source separation model or a first trained denoising model. In the context of this specification, the term ‘source separation model’ may be understood as a (blind) signal separation or (blind) source separation model such as, e.g., a deep neural network (DNN) or a digital signal processing (DSP) algorithm utilized to separate, e.g., an impact of one or more speech sources and/or an impact of one or more noise/ambience sources from an audio signal. In the context of this specification, the term ‘denoising model’ may be understood as a model such as, e.g., a DNN or a DSP algorithm utilized to remove an impact of one or more noise sources from an audio signal. In an example embodiment, the first trained source separation model may be a first source separation deep neural network, as explained in more detail below with reference to FIG. 6. In an example embodiment, the first trained denoising model may be a first denoising deep neural network, as explained in more detail below with reference to FIG. 7. In the context of this specification, the term ‘deep neural network’ may be understood as an artificial neural network comprising multiple layers between an input layer and an output layer. In an example embodiment, operations 203 and 204 may be performed substantially simultaneously using one trained source separation model or trained denoising model.

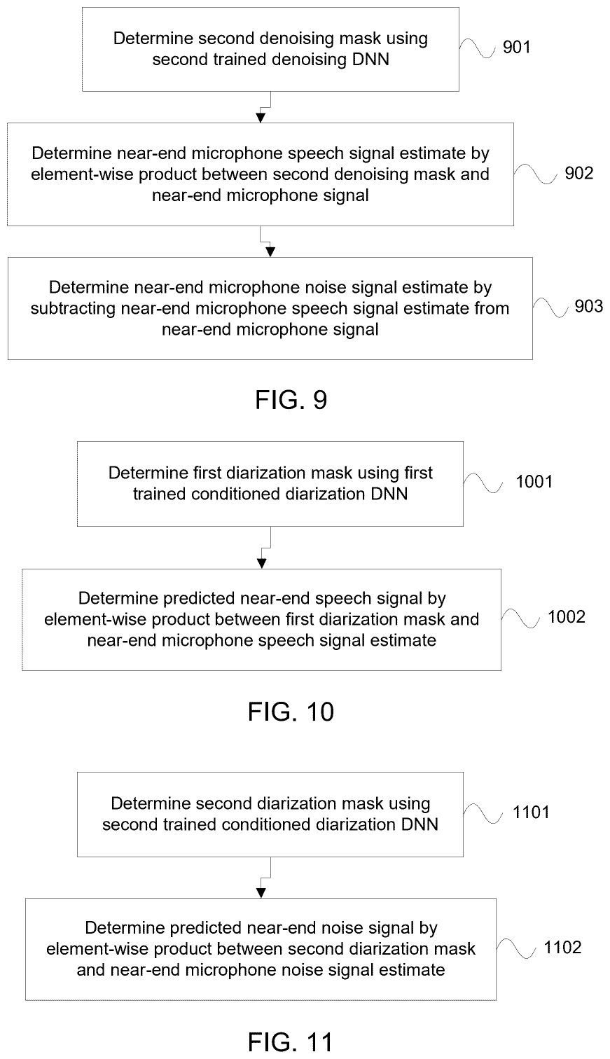

Referring to FIG. 2 and FIG. 3, a near-end microphone speech signal estimate \hat{x}_{fn} 336 and a near-end microphone noise signal estimate \hat{η}_{fn} 338 are determined at operation 204, based on at least the near-end microphone signal 320. In an example embodiment, the determining the near-end microphone speech signal estimate 336 and the near-end microphone noise signal estimate 338 further comprises use of a second trained source separation model or a second trained denoising model. In an example embodiment, the second trained source separation model may be a second source separation deep neural network, as explained in more detail below with reference to FIG. 8. In an example embodiment, the second source separation model may be the first source separation model, which may be understood as the first source separation model having been trained to source separate both the far-end signal and the near-end microphone signal substantially simultaneously, e.g., using concatenation of the far-end signal and the near-end microphone signal. In an example embodiment, the second trained denoising model may be a second denoising deep neural network, as explained in more detail below with reference to FIG. 9. In an example embodiment, the second denoising model may be the first denoising model, which may be understood as the first denoising model having been trained to denoise both the far-end signal and the near-end microphone signal substantially simultaneously, e.g., using concatenation of the far-end signal and the near-end microphone signal. The far-end signal 310 and the near-end microphone signal 320 may be understood as input for the at least one trained source separation/denoising model 330. The far-end speech signal estimate 332, the far-end noise signal estimate 334, the near-end microphone speech signal estimate 336, and the near-end microphone noise signal estimate 338 may be understood as output of the at least one trained source separation/denoising model 330.

Referring to FIG. 2 and FIG. 3, a predicted near-end speech signal \hat{x}ₙ 342 is determined at operation 205, based on at least the far-end speech signal estimate 332 and the near-end microphone speech signal estimate 336. The predicted near-end speech signal 342 is determined by attenuating an impact of the at least one far-end speech source 312 from the near-end microphone speech signal estimate 336. A predicted near-end noise signal \hat{η}ₙ 344 is determined at operation 206, based on at least the far-end noise signal estimate 334 and the near-end microphone noise signal estimate 338. The predicted near-end noise signal 344 is determined by attenuating an impact of the at least one far-end noise source 314 from the near-end microphone noise signal estimate 338. In an example embodiment, operations 205 and 206 may be performed substantially simultaneously using one trained conditioned diarization model.

Referring to FIG. 2, the predicted near-end speech signal 342 and the predicted near-end noise signal 344 are output at operation 207. In an example embodiment, the predicted near-end speech signal 342 and the predicted near-end noise signal 344 may be output as a combined signal. In another alternative or additional example embodiment, the predicted near-end speech signal 342 and the predicted near-end noise signal 344 may be output as separate signals. In example embodiments, the predicted near-end speech signal 342 and the predicted near-end noise signal 344 may be determined using, e.g., one or more trained conditioned diarization models 340 such as, e.g., deep neural networks, as explained in more detail below with reference to FIGS. 10 and 11. In the context of this specification, the term ‘conditioned diarization model’ may be understood as a model trained to take as input a mixture of two signals and a predicted version or an estimate of a first signal within the two signals. The model is trained to give as output a predicted version or an estimate of a second signal within the two signals. The first signal may be understood as a conditioning signal for the conditioned diarization model 340.

FIG. 4 is a diagram illustrating signals obtained, determined, and output within an example functionality of an apparatus configured to perform acoustic echo cancellation (AEC) and/or residual echo suppression (RES) using trained source separation models according to an example embodiment.

Referring to FIG. 4, a far-end signal s_{f} 310 is obtained. The far-end signal is based on at least one far-end speech source 312 (generating a far-end speech signal x_{f}) and at least one far-end noise source 314 (generating a far-end noise signal η_{f}). In an example embodiment, the far-end signal 310 is captured by a far-end microphone 316. A near-end microphone signal s_{fn} 320 is obtained. The near-end microphone signal 320 is captured by a near-end microphone 328. The near-end microphone signal is based on at least one near-end speech source 322 (generating a near-end speech signal xₙ), at least one near-end noise source 324 (generating a near-end noise signal ηₙ), and an altered far-end signal \tilde{s}_{f} 326. The near-end microphone signal may be understood to be a linear combination of signals, which may be formulated as s_{fn}=sₙ+\tilde{s}_{f}=xₙ+ηₙ+\tilde{s}_{f}. In an example embodiment, the altered far-end signal 326 comprises the far-end signal 310, reproduced by at least one near-end speaker 350 and possibly altered by near-end environment acoustics, such as, e.g., room acoustics.

Referring to FIG. 4, a far-end speech signal estimate ff 332 and a far-end noise signal estimate ff 334 are determined, based on at least the far-end signal 310, using a first trained source separation model 430a. In an example embodiment, the first trained source separation model 430a may be a first source separation deep neural network 431a that may be used to generate a first source separation mask 432, as explained in more detail below with reference to FIG. 6. The far-end signal 310 may be understood as input for the first trained source separation model 430a. The far-end speech signal estimate 332 and the far-end noise signal estimate 334 may be understood as output of the first trained source separation model 430a. A near-end microphone speech signal estimate \hat{x}_{fn} 336 and a near-end microphone noise signal estimate \hat{η}_{fn} 338 are determined, based on at least the near-end microphone signal 320, using a second trained source separation model 430b. In an example embodiment, the second source separation model 430b may be the first source separation model 430a, which may be understood as the first source separation model 430a trained to source separate both the far-end signal 310 and the near-end microphone signal 320 substantially simultaneously, e.g., using concatenation of the far-end signal 310 and the near-end microphone signal 320. In an example embodiment, the second trained source separation model 430b may be a second source separation deep neural network 431b that may be used to generate a second source separation mask 434, as explained in more detail below with reference to FIG. 8. The near-end microphone signal 320 may be understood as input for the second trained source separation model 430b. The near-end microphone speech signal estimate 336 and the near-end microphone noise signal estimate 338 may be understood as output of the second trained source separation model 430b.

Referring to FIG. 4, a predicted near-end speech signal \hat{x}ₙ 342 is determined, based on at least the far-end speech signal estimate 332 and the near-end microphone speech signal estimate 336, using a first trained conditioned diarization model 440a. In an example embodiment, the first trained conditioned diarization model 440a may be first trained conditioned diarization deep neural network 441a used to generate a first diarization mask 442, as explained in more detail below with reference to FIG. 10. A predicted near-end noise signal \hat{η}ₙ 344 is determined, based on at least the far-end noise signal estimate 334 and the near-end microphone noise signal estimate 338, using a second trained conditioned diarization model 440b. In an example embodiment, the second trained conditioned diarization model 440b may be a second trained conditioned diarization deep neural network 441b used to generate a second diarization mask 444, as explained in more detail below with reference to FIG. 11.

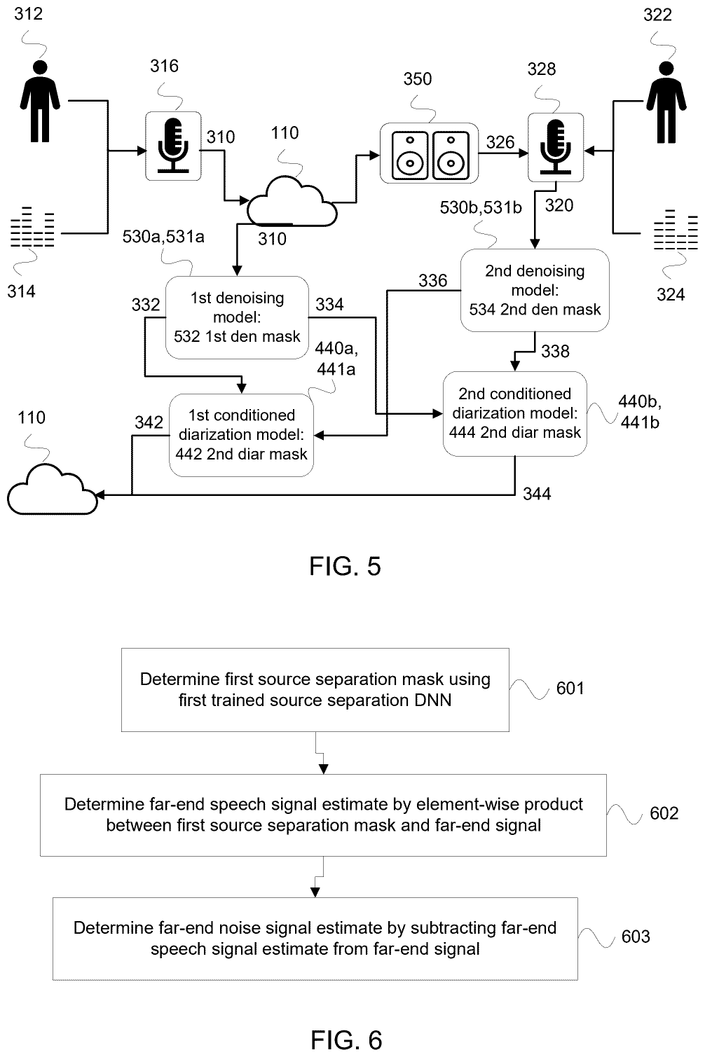

FIG. 5 is a diagram illustrating signals obtained, determined, and output within an example functionality of an apparatus configured to perform acoustic echo cancellation (AEC) and/or residual echo suppression (RES) using trained denoising models according to an example embodiment.

Referring to FIG. 5, a far-end signal s_{f} 310 is obtained. The far-end signal is based on at least one far-end speech source 312 (generating a far-end speech signal x_{f}) and at least one far-end noise source 314 (generating a far-end noise signal η_{f}). In an example embodiment, the far-end signal 310 is captured by a far-end microphone 316. A near-end microphone signal s_{fn} 320 is obtained. The near-end microphone signal 320 is captured by a near-end microphone 328. The near-end microphone signal is based on at least one near-end speech source 322 (generating a near-end speech signal xₙ), at least one near-end noise source 324 (generating a near-end noise signal ηₙ), and an altered far-end signal \tilde{s}_{f} 326. The near-end microphone signal may be understood to be a linear combination of signals, which may be formulated as s_{fn}=sₙ+\tilde{s}_{f}=xₙ+ηₙ+\tilde{s}_{f}. In an example embodiment, the altered far-end signal 326 comprises the far-end signal 310, reproduced by at least one near-end speaker 350 and possibly altered by near-end environment acoustics, such as, e.g., room acoustics.

Referring to FIG. 5, a far-end speech signal estimate \hat{x}_{f} 332 and a far-end noise signal estimate \hat{η}_{f} 334 are determined, based on at least the far-end signal 310, using a first trained denoising model 530a. In an example embodiment, the first trained denoising model 530a may be a first denoising deep neural network 531a used to generate a first denoising mask 532, as explained in more detail below with reference to FIG. 7. The far-end signal 310 may be understood as input for the first trained denoising model 530a. The far-end speech signal estimate 332 and the far-end noise signal estimate 334 may be understood as output of the first trained denoising model 530a. A near-end microphone speech signal estimate \hat{x}_{fn} 336 and a near-end microphone noise signal estimate \hat{η}_{fn} 338 are determined, based on at least the near-end microphone signal 320, using a second trained denoising model 530b. In an example embodiment, the second denoising model 530b may be the first denoising model 530a, which may be understood as the first denoising model 530a trained to denoise both the far-end signal 310 and the near-end microphone signal 320 substantially simultaneously, e.g., using concatenation of the far-end signal 310 and the near-end microphone signal 320. In an example embodiment, the second trained denoising model 530b may be a second denoising deep neural network 531b used to generate a second denoising mask 534, as explained in more detail below with reference to FIG. 9. The near-end microphone signal 320 may be understood as input for the second trained denoising model 530b. The near-end microphone speech signal estimate 336 and the near-end microphone noise signal estimate 338 may be understood as output of the second trained denoising model 530b.

Referring to FIG. 5, a predicted near-end speech signal \hat{x}ₙ 342 is determined, based on at least the far-end speech signal estimate 332 and the near-end microphone speech signal estimate 336, using the first trained conditioned diarization model 440a. In an example embodiment the first trained conditioned diarization model 440a may be the first trained conditioned diarization deep neural network 441a used to generate the first diarization mask 442, as explained in more detail below with reference to FIG. 10. A predicted near-end noise signal \hat{η}ₙ 344 is determined, based on at least the far-end noise signal estimate 334 and the near-end microphone noise signal estimate 338, using the second trained conditioned diarization model 440b. In an example embodiment, the second trained conditioned diarization model 440b may be the second trained conditioned diarization deep neural network 441b used to generate the second diarization mask 444, as explained in more detail below with reference to FIG. 11.

FIG. 6 illustrates an example functionality of an apparatus according to an example embodiment utilizing the first trained source separation model 430a. The functionalities illustrated in FIG. 6 may be carried out within operation 203 of FIG. 2.

Referring to FIG. 6, the first trained source separation model 430a is the first trained source separation deep neural network (DNN) 431a. The first source separation mask 432 is determined at operation 601, based on the far-end signal 310, using the first trained source separation DNN. The far-end speech signal estimate 332 is determined at operation 602 by element-wise (Hadamard) product between the first source separation mask 432 and the far-end signal 310. The far-end noise signal estimate 334 is determined at operation 603 by subtracting the far-end speech signal estimate 332 from the far-end signal 310.

FIG. 7 illustrates an example functionality of an apparatus according to an example embodiment utilizing the first trained denoising model 530a. The functionalities illustrated in FIG. 7 may be carried out within operation 203 of FIG. 2. Referring to FIG. 7, the first trained denoising model 530a is the first trained denoising deep neural network (DNN) 531a. The first denoising mask 532 is determined at operation 701, based on the far-end signal 310, using the first trained denoising DNN. The far-end speech signal estimate 332 is determined at operation 702 by element-wise product between the first denoising mask 532 and the far-end signal 310. The far-end noise signal estimate 334 is determined at operation 703 by subtracting the far-end speech signal estimate 332 from the far-end signal 310.

FIG. 8 illustrates an example functionality of an apparatus according to an example embodiment utilizing the second trained source separation model 430b. The functionalities illustrated in FIG. 8 may be carried out within operation 204 of FIG. 2. Referring to FIG. 8, the second trained source separation model 430b is the second trained source separation deep neural network (DNN) 431b. The second source separation mask 434 is determined at operation 801, based on the near-end microphone signal 320, using the second trained source separation DNN. The near-end microphone speech signal estimate 336 is determined at operation 802 by element-wise product between the second source separation mask 434 and the near-end microphone signal 320. The near-end microphone noise signal estimate 338 is determined at operation 803 by subtracting the near-end microphone speech signal estimate 336 from the near-end microphone signal 320.

FIG. 9 illustrates an example functionality of an apparatus according to an example embodiment utilizing the second trained denoising model 530b. The functionalities illustrated in FIG. 9 may be carried out within operation 204 of FIG. 2.

Referring to FIG. 9, the second trained denoising model 530b is the second trained denoising deep neural network (DNN) 531b. The second denoising mask 534 is determined at operation 901, based on the near-end microphone signal 320, using the second trained denoising DNN. The near-end microphone speech signal estimate 336 is determined at operation 902 by element-wise product between the second denoising mask 534 and the near-end microphone signal 320. The near-end noise signal estimate 338 is determined at operation 903 by subtracting the near-end microphone speech signal estimate 336 from the near-end microphone signal 320.

The source separation/denoising process described above with reference to FIGS. 4 to 9 may be formulated as equations:

$${\hat{M}}_{sep} = {DNN}_{sep} ( \overline{s} ) ,$$

$$\hat{x} = {\hat{M}}_{sep} ⊙ \overline{s} , and$$

$$\hat{η} = \overline{s} - \hat{x} ,$$

where DNNₛₑₚ may be understood as a trained source separation/denoising deep neural network such as the first trained source separation DNN 431a, the second trained source separation DNN 431b, the first trained denoising DNN 531a, or the second trained denoising DNN 531b. s̅ may be understood as a signal used as input such as the far-end signal 310 s_{f}, the near-end microphone signal 320 s_{fn}, or a concatenation of the far-end signal 310 and the near-end microphone signal 320. \hat{M}ₛₑₚ may be understood as a source separation/denoising mask such as the first source separation mask 432, the first denoising mask 532, the second source separation mask 434, or the second denoising mask 534. Operator ⊙ may be understood as element-wise (Hadamard) product. \hat{x} may be understood as a speech signal estimate such as the far-end speech signal estimate 332 \hat{x}_{f}, the near-end microphone speech signal estimate 336 \hat{x}_{fn}, or a concatenation of the far-end speech signal estimate 332 and the near-end microphone speech signal estimate 336. \hat{η} may be understood as a noise signal estimate such as the far-end noise signal estimate 334 \hat{η}_{f}, the near-end microphone noise signal estimate 338 \hat{η}_{fn}, or a concatenation of the far-end noise signal estimate 334 and the near-end microphone noise signal estimate 338.

FIG. 10 illustrates an example functionality of an apparatus according to an example embodiment utilizing the first trained conditioned diarization model 440a. The functionalities illustrated in FIG. 10 may be carried out within operation 205 of FIG. 2.

Referring to FIG. 10, the first trained conditioned diarization model 440a is the first trained conditioned diarization deep neural network 441a. The first diarization mask 442 is determined at operation 1001, based on the near-end microphone speech signal estimate 336 and the far-end speech signal estimate 332, using the first trained conditioned diarization DNN. The predicted near-end speech signal 342 is determined at operation 1002 by element-wise product between the first diarization mask 442 and the near-end microphone speech signal estimate 336. The near-end microphone speech signal estimate 336 may be understood to comprise a mixture of a signal from the far-end speech source 312 and a signal from the near-end speech source 322, and the first conditioned diarization model 440a may thus be utilized to attenuate the impact of the far-end speech source 312 to obtain an estimate/prediction of the signal from near-end speech source 322.

FIG. 11 illustrates an example functionality of an apparatus according to an example embodiment utilizing the second trained conditioned diarization model 440b. The functionalities illustrated in FIG. 11 may be carried out within operation 206 of FIG. 2.

Referring to FIG. 11, the second trained conditioned diarization model 440b is the second trained conditioned diarization deep neural network 441b. The second diarization mask 444 is determined at operation 1101, based on the near-end microphone noise signal estimate 338 and the far-end noise signal estimate 334, using the second trained conditioned diarization DNN. The predicted near-end noise signal 344 is determined at operation 1102 by element-wise product between the second diarization mask 444 and the near-end microphone noise signal estimate 344. The near-end microphone noise signal estimate 338 may be thought to comprise a mixture of a signal from the far-end noise source 314 and a signal from the near-end noise source 324, and the second conditioned diarization model 440b may thus be utilized to attenuate the impact of the far-end noise source 314 to obtain an estimate/prediction of the signal from near-end noise source 324.

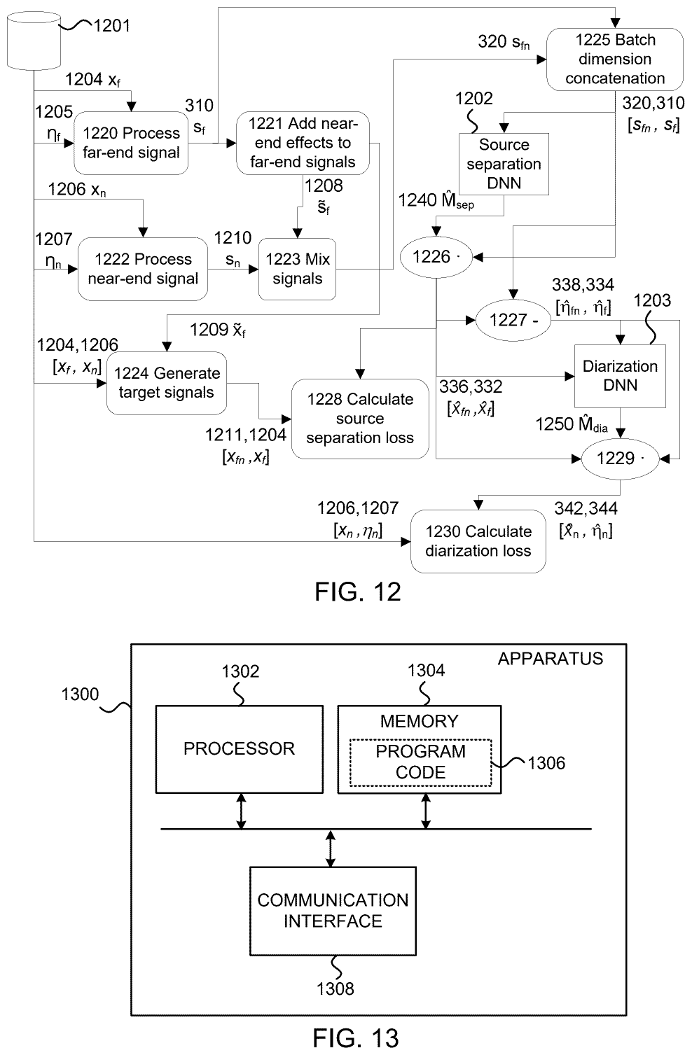

The conditioned diarization process described above with reference to FIGS. 10 and 11 may be formulated as equations:

$${\hat{M}}_{dia} = {DNN}_{dia} ( \overline{y} , {y}_{a} ) , and$$

$${\hat{y}}_{b} = {\hat{M}}_{dia} ⊙ \overline{y} ,$$

where DNN_{dia} may be understood as a conditioned diarization DNN such as the first trained conditioned diarization DNN or the second trained conditioned diarization DNN. y̅=y̅ₐ+y_{b} may be understood as a signal to be attenuated such as the near-end microphone speech signal estimate 336 \hat{x}_{fn} or the near-end microphone noise signal estimate 338 \hat{η}_{fn}. The signal to be attenuated may be understood as a mixture or a linear combination of a targeted signal y_{b} such as the signal from the near-end speech source 322 xₙ or the signal from the near-end noise source 324 ηₙ, and a conditioning signal y̅ₐ such as the far-end speech signal estimate 332 ff or the far-end noise signal estimate 334 \hat{η}_{f}. \hat{M}_{dia} may be understood as a diarization mask such as the first diarization mask 442 or the second diarization mask 444. Operator ⊙ may be understood as element-wise (Hadamard) product. ŷ_{b} may be understood as a result signal such as, e.g., the predicted near-end speech signal 342 \hat{x}ₙ or the predicted near-end noise signal 344 \hat{η}ₙ. FIG. 12 illustrates an example training process of an example functionality of an apparatus according to an example embodiment. The training process illustrated in FIG. 12 comprises an example of one input and one output. Using multiple inputs and outputs substantially simultaneously may be implemented by increasing batch dimension to comprise a plurality of training signal examples. In the example functionality the apparatus uses one source separation DNN 1202 and one conditioned diarization DNN 1203 for batch dimension concatenated signals.

Training the source separation/denoising deep neural network(s) 431a, 431b, 531a, 531b or combination(s) thereof may be implemented using a training dataset comprising signals for optimization, which may be formulated as

$${θ}_{sep}^{⋆} = arg {min}_{{θ}_{sep}} {ℒ}_{sep} ( x , {DNN}_{sep} ( \overline{s} ) ⊙ \overline{s} ) ,$$

where θₛₑₚ may be understood as trainable parameters of the DNNₛₑₚ, [symbol] ₛₑₚ may be understood as a loss function used for the training, and x may be understood as output matched to input s̅, wherein x and s̅ are drawn/sampled from the training dataset.

Training the conditioned diarization deep neural network(s) 441a, 441b or a combination thereof may be implemented using a training dataset comprising signals for optimization, which may be formulated as

$${θ}_{dia}^{⋆} = arg {min}_{{θ}_{dia}} {ℒ}_{dia} ( {y}_{b} , {DNN}_{dia} ( {y}_{a} , \overline{y} ) ⊙ \overline{y} ) ,$$

where θ_{dia} may be understood as trainable parameters of the DNN_{dia}, [symbol] _{dia} may be understood as a loss function used for the training, and y_{b} may be understood as output that is matched to input (yₐ,y̅), wherein y_{b}, yₐ and y̅ are drawn/sampled from the training dataset.

Training the source separation/denoising deep neural network(s) 431a, 431b, 531a, 531b and the conditioned diarization deep neural network(s) 441a, 441b may be implemented to be performed substantially simultaneously by using a combined

$${ℒ}_{tot} = {ℒ}_{sep} + {ℒ}_{dia} ,$$

where [symbol] ₜₒₜ may be understood as a loss function used for the training.

Referring to FIG. 12, one or more datasets 1201 comprise signal data for the training process, e.g., at least the far-end speech signal 1204 x_{f}, the far-end noise signal 1205 η_{f}, the near-end speech signal 1206 xₙ, and the near-end noise signal 1207 ηₙ. The far-end speech signal 1204 x_{f} and the near-end signal 1206 xₙ may be sampled from a clean speech signal dataset. The far-end noise signal 1205 η_{f} and the near-end noise signal 1207 ηₙ may be sampled from a clean noise signal dataset. The far-end speech signal 1204 x_{f} and the far-end noise signal 1205 η_{f} are processed and/or augmented at operation 1220 to obtain the far-end signal 310 s_{f}. A far-end room impulse response may be used in the processing to obtain the far-end signal 310 s_{f}. The far-end room impulse response may be sampled from a room impulse response dataset. Near-end effects such as, e.g., alteration caused by the near-end loudspeakers, are added at operation 1221 to the far-end signal 310 s_{f} and the far-end speech signal 1204 x_{f} to obtain the altered far-end signal 1208 \tilde{s}_{f} and an altered far-end speech signal 1209 \tilde{x}_{f}. The near-end speech signal 1206 xₙ and the near-end noise signal 1207 ηₙ are processed and/or augmented at operation 1222 to obtain the near-end signal 1210 sₙ. A near-end room impulse response may be used in the processing to obtain the near-end signal 1210. The near-end room impulse response may be sampled from the room impulse response dataset. The altered far-end signal 1208 \tilde{s}_{f} and the near-end signal 1210 sₙ are mixed at operation 1223 to obtain the near-end microphone signal 320 s_{fn}. Target signals, i.e., the far-end speech signal 1204 x_{f} and a near-end microphone speech signal 1211 x_{fn} are generated at operation 1224. The far-end signal 310 s_{f} and the near-end microphone signal 320 s_{fn} are concatenated at operation 1255 to obtain a batch dimension concatenation of near-end microphone signal 320 and far-end signal 310 [s_{fn},s_{f}] for training the source separation DNN 1202. A source separation mask 1240 \hat{M}ₛₑₚ is output from the source separation DNN 1202 using an input of the concatenation of near-end microphone signal 320 and far-end signal 310 [s_{fn},s^{f}]. The source separation mask 1240 \hat{M}ₛₑₚ is then element-wise multiplied at operation 1226 with the concatenation of the near-end microphone signal 320 and the far-end signal 310 [s_{fn},s_{f}] to obtain a concatenation of the near-end microphone speech signal estimate 336 and the far-end speech signal estimate 332 [\hat{x}_{fn},\hat{x}_{f}]. The concatenation of the near-end microphone speech signal estimate 336 and the far-end speech signal estimate 332 [\hat{x}_{fn},\hat{x}_{f}] is subtracted at operation 1227 from the concatenation of the near-end microphone signal 320 and the far-end signal 310 [s_{fn},s_{f}] to obtain a concatenation of the near-end microphone noise signal estimate 338 and the far-end noise signal estimate 334 [\hat{η}_{fn},\hat{η}_{f}]. Source separation loss [symbol] ₛₑₚ is calculated at operation 1228 using the concatenation of the near-end microphone speech signal estimate 336 and the far-end speech signal estimate 332 [\hat{x}_{fn},\hat{x}_{f}] and a concatenation of the near-end microphone speech signal 1211 and the far-end speech signal 1204 [x_{fn},x_{f}].

Referring to FIG. 12, a diarization mask 1250 \hat{M}ₛₑₚ is output from the diarization DNN 1203 from an input of the concatenation of the near-end microphone speech signal estimate 336 and the far-end speech signal estimate 332 [\hat{x}_{fn},\hat{x}_{f}] and the concatenation of the near-end microphone noise signal estimate 338 and the far-end noise signal estimate 334 [\hat{η}_{fn},\hat{η}_{f}]. The diarization mask 1250 \hat{M}_{dia} is then element-wise multiplied at operation 1229 with the near-end microphone speech signal estimate 336 and the near-end microphone noise signal estimate 338 [\hat{x}_{fn},\hat{η}_{fn}] to obtain the predicted near-end speech signal 342 \hat{x}ₙ and the predicted near-end noise signal 344 \hat{η}ₙ. Diarization loss [symbol] _{dia} is calculated at operation 1230 using the predicted near-end speech signal 342 and the predicted near-end noise signal 344 [\hat{x}ₙ,\hat{η}ₙ] and the near-end speech signal 1206 and the near-end noise signal 1207 [xₙ,ηₙ].

The methods disclosed herein, e.g., with reference to FIGS. 2 to 5 are model agnostic and may be utilized regardless of the model(s) deployed. The example embodiments disclosed, e.g., with reference to FIGS. 6 to 11 present examples of suitable trained models but also other examples of trained models may be utilized. Any type of deep neural network may be used for source separation, denoising, and/or diarization. An example of such DNN is UNet architecture, using either a single encoder or a dual encoder. Another example of such DNN may be based on recurrent neural networks (RNN) such as TasNet.

In an exemplary real-life use case, the far-end digital audio signal 310 is received in a user device 125, 135 and the received far-end signal 310 is processed with the first denoising model 530a. Then, the far-end signal 310 is reproduced by a near-end reproduction device such as, e.g. one or more loudspeakers 350 of the user device 125, 135. In some implementations, the one or more loudspeakers 350 may be separate from the user device 125, 135. Signals from the near-end sources 322, 324 received in the user device 125, 135 are naturally mixed with the altered (reproduced) far-end signal 326 and captured by one ore more near-end microphones 328 such as, e.g., a microphone of the user device 125, 135. In some implementations, the one or more of near-end microphones 328 may be separate from, but connected to, the user device 125, 135. Then, noise is removed from the captured near-end microphone signal 320 by the second denoising model 530b. The far-end speech signal estimate 332 and the near-end microphone speech signal estimate 336 may be combined as one speech signal for further processing by the first conditioned diarization model 440a to remove the effect of the far-end speech source(s) 312, resulting in the predicted near-end speech signal 342. The far-end noise signal estimate 334 and the near-end microphone noise signal estimate 338 may be combined as one noise signal for further processing by the second conditioned diarization model 440b to remove the effect of the far-end noise source(s) 314, resulting in the predicted near-end noise signal 344. The predicted near-end speech signal 342 and the predicted near-end noise signal 344 may be output, such as sent or transmitted, as a combined signal or as two separate signals to be, e.g., combined and/or processed at a receiving end of the signals. If the predicted near-end speech signal 342 and the predicted near-end noise signal are output, such as sent or transmitted, as the two separate signals or two separate information in one signal, then a receiving device, similar, e.g., to the user device 125, 135, may mix or render, such as playback or reproduce, the two signals or information, based on preferences or adjustments of the user of the receiving device. For example, in some use case the user may want to suppress received noise to have clear speech, and in some other use case the user may want to enhance the received noise to have better understanding on surrounding environment.

Examples of codecs/standards that are suitable for encoding/decoding audio signals, such as a far-end signal ss 310, a near-end microphone signal s_{fn} 320, a predicted near-end speech signal \hat{x}ₙ 342, and a predicted near-end noise signal \hat{η}ₙ 344, and for implementing various embodiments of the invention comprise at least 3GPP Immersive Voice and Audio Services (IVAS), Opus Audio Codec, Advanced Audio Coding (AAC), Adaptive Multi-Rate Wideband (AMR-WB), and/or 3GPP Enhanced Voice Services (EVS), or any other relevant codec/standard. In case of the IVAS, the predicted near-end speech signal \hat{x}ₙ 342 and the predicted near-end noise signal \hat{η}ₙ 344 may be output, such as sent or transmitted, in any combination of, for example, one or more of a multi-channel audio (5.1, 5.1.2, 5.1.4, 7.1, 7.1.4 setups), scene-based audio, metadata assisted spatial audio (MASA), or object-based audio (Independent Stream with Metadata (ISM)).

FIG. 13 illustrates an example embodiment of an apparatus 1300 configured to practice one or more example embodiments. The apparatus 1300 may comprise the user device 125, 135, or the cloud device 140, e.g., a terminal apparatus, a user node, a user equipment, a cloud node, or in general a device configured to implement the functionality described herein, which may be connected via wired and/or wireless communication protocols. Although the apparatus 1300 is illustrated as a single device, it is appreciated that, wherever applicable, functions of the apparatus 1300 may be distributed to a plurality of devices.

The user device 125, 135 may refer to a device (e.g. a portable or non-portable computing device) that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. The user device may also utilize cloud. In some applications, a user device may comprise a user portable device with radio parts (such as a watch, earphones, eyeglasses, other wearable accessories or wearables) and the computation is carried out in the cloud. The device is configured to perform one or more of user equipment functionalities. The user device may also be called a subscriber unit, mobile station, remote terminal, access terminal, user terminal or user equipment (UE) just to mention but a few names or apparatuses.

The apparatus 1300 may comprise at least one processor 1302. The at least one processor 1302 may comprise, for example, one or more of various processing devices or processor circuitry, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, an artificial intelligence (AI) accelerator, a neural processing unit (NPU), or the like, or any combination thereof. In an embodiment, the processor 1302 may be configured to execute hard-coded functionality. In an embodiment, the processor 1302 is embodied as an executor of soft-ware instructions, wherein the instructions may con-figure the processor 1302 to perform the algorithms and/or operations described herein when the instructions are executed.

The apparatus 1300 may further comprise at least one memory 1304. The at least one memory 1304 may be configured to store, for example, computer program code or the like, for example operating system software and application software. The at least one memory 1304 may comprise one or more volatile memory devices, one or more non-volatile memory devices, and/or a combination thereof. For example, the at least one memory 1304 may be embodied as magnetic storage devices (such as hard disk drives, floppy disks, magnetic tapes, etc.), optical magnetic storage devices, or semiconductor memories (such as mask ROM (read-only memory), PROM (programmable ROM), EPROM (erasable PROM), flash ROM, RAM (random access memory), etc.).

The apparatus 1300 may further comprise one or more wired and/or wireless communication interfaces 1308 configured to enable the apparatus 1300 to transmit and/or receive information to/from other devices. In one example, the apparatus 1300 may use the communication interface 1308 to transmit or receive signaling information and data in accordance with at least one data communication or cellular communication protocol. The communication interface 1308 may be configured to provide at least one wireless radio connection, such as, for example, a 3GPP mobile broadband connection (e.g., 3G, 4G, 5G, 6G etc.). The communication interface 1308 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas. The communication interface 1308 may comprise a receiver, a transmitter, or a transceiver.

The apparatus 1300 may further comprise one or more speakers. Alternatively, the one or more speakers may be comprised in another apparatus such as, e.g., a user device or an external speaker device, and signals reproduced by the one or more speakers may be obtained by the apparatus 1300 via, e.g., the communication interface 1308. The apparatus 1300 may further comprise one or more microphones. Alternatively, the one or more microphones may be comprised in another apparatus such as, e.g., a user device or an external microphone device, and signals captured by the one or more microphones may be obtained by the apparatus 1300 via, e.g., the communication interface 1308.

When the apparatus 1300 is configured to implement some functionality, some component and/or components of the apparatus 1300, such as for example the at least one processor 1302 and/or the at least one memory 1304, may be configured to implement this functionality. Furthermore, when the at least one processor 1302 is configured to implement some functionality, this functionality may be implemented using program code 1306 comprised, for example, in the at least one memory 1304.

The functionality described herein may be performed, at least in part, by one or more computer program product components such as for example software components. According to an example embodiment, the apparatus 1300 may comprise a processor or processor circuitry, such as for example a microcontroller, configured by the program code when executed to execute the embodiments of the operations and functionality described. The program code 1306 is provided as an example of instructions which, when executed by the at least one processor 1302, cause performance of apparatus. Alternatively, or additionally, the functionality described herein may be performed, at least in part, by one or more hardware logic components. For example, and without limitation, illustrative types of hardware logic components that may be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (GPUs).

The apparatus 1300 may be configured to perform or cause performance of any aspect of the method(s) described herein. Further, a computer program may comprise instructions for causing, when executed, an apparatus to perform any aspect of the method(s) described herein. The computer program may be stored on a computer-readable medium. Further, the apparatus 1300 may comprise means for performing any aspect of the method(s) described herein. In one example, the means may comprise the at least one processor 1302, the at least one memory 1304 including the program code 1306 (instructions) configured to, when executed by the at least one processor 1302, cause the apparatus 1300 to perform the method(s). In general, computer program instructions may be executed on means providing generic processing functions. The method(s) may be thus computer-implemented, for example, algorithm(s) executable by the generic processing functions, an example of which is the at least one processor 1302. The means may comprise transmission and/or reception means, for example one or more radio transmitters or receivers, which may be coupled or be configured to be coupled to one or more antennas, or transmitter(s) or receiver(s) of a wired communication interface.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (t) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile device or a similar integrated circuit in a sensor, a cellular network device, or another network device.

Although the subject matter has been described in language specific to structural features and/or acts, it is to be understood that the subject matter defined in the appended claims is not necessarily limited to the specific features or acts described above. Rather, the specific features and acts described above are disclosed as example embodiments of implementing the claims and other equivalent features and acts are intended to be within the scope of the claims.

It will be understood that the benefits and advantages described above may relate to one example embodiment or may relate to several example embodiments. The example embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or substantially simultaneously where appropriate. Additionally, individual blocks may be deleted from any of the methods without departing from the scope of the subject matter described herein. Aspects of any of the example embodiments described above may be combined with aspects of any of the other example embodiments described to form further example embodiments without losing the effect sought.

It will be understood that the above description is given by way of example embodiments only and that various modifications may be made by those skilled in the art. The above specification, example embodiments and data provide a complete description of the structure and use of exemplary embodiments. Although various example embodiments have been described above with a certain degree of particularity. or with reference to one or more individual embodiments, those skilled in the art could make numerous alterations to the disclosed example embodiments without departing from scope of this specification.

1. An apparatus comprising:
at least one processor; and
at least one memory storing instructions that, when executed by the at least one processor, cause the apparatus to at least:
obtain a far-end signal (310 s_{f}), the far-end signal (310 s_{f}) being based on at least one far-end speech source (312) and at least one far-end noise source (314);
obtain at least one near-end microphone signal (320 s_{fn}) captured by one or more near-end microphones (328), the at least one near-end microphone signal (320 s_{fn}) being based on at least one near-end speech source (322), at least one near-end noise source (324), and an altered far-end signal (326 \tilde{s}_{f});
determine, based on at least the far-end signal (310 s_{f}), a far-end speech signal estimate (332 \tilde{x}_{f}) and a far-end noise signal estimate (334 \hat{η}_{f});
determine, based on the at least one near-end microphone signal (320 s_{fn}), a near-end microphone speech signal estimate (336 \hat{x}_{fn}) and a near-end microphone noise signal estimate (338 \hat{η}_{fn});
determine, based on at least the far-end speech signal estimate (332 \hat{x}_{f}) and the near-end microphone speech signal estimate (336 \hat{x}_{fn}), a predicted near-end speech signal (342 \hat{x}ₙ) by attenuating an impact of the at least one far-end speech source (312) from the near-end microphone speech signal estimate (336 \hat{x}_{fn});
determine, based on at least the far-end noise signal estimate (334 \hat{η}_{f}) and the near-end microphone noise signal estimate (338 \hat{η}_{fn}), a predicted near-end noise signal (344 \hat{η}ₙ) by attenuating an impact of the at least one far-end noise source (314) from the near-end microphone noise signal estimate (338 \hat{n}_{fn}); and
output at least the predicted near-end speech signal (342 \hat{x}ₙ) and predicted near-end noise signal (344 \hat{η}ₙ).

2. An apparatus according to claim 1, wherein the determining the far-end speech signal estimate (332 \hat{x}_{f}) and the far-end noise signal estimate (334 \hat{η}_{f}) further comprises use of a first trained source separation model (430a) or a first trained denoising model (530a).

3. An apparatus according to claim 2, wherein the first trained source separation model (430a) is a first trained source separation deep neural network (431a), and wherein the determining the far-end speech signal estimate (332 \hat{x}_{f}) and the far-end noise signal estimate (334 \hat{η}_{f}) further causes the apparatus to:
determine, based on the far-end signal (310 s_{f}), using the first trained source separation deep neural network (431a), a first source separation mask (432);
determine the far-end speech signal estimate (332 \hat{x}_{f}) by element-wise product between the first source separation mask (432) and the far-end signal (310 s_{f}); and
determine the far-end noise signal estimate (334 η_{f}) by subtracting the far-end speech signal estimate (332 \hat{x}_{f}) from the far-end signal (310 s_{f}).

4. An apparatus according to claim 2, wherein the first trained denoising model (530a) is a first trained denoising deep neural network (531a), and wherein the determining the far-end speech signal estimate (332 \hat{x}_{f}) and the far-end noise signal estimate (334 \hat{η}_{f}) further causes the apparatus to:
determine, based on the far-end signal (310 s_{f}), using the first trained denoising deep neural network (531a), a first denoising mask (532);
determine the far-end speech signal estimate (332 \hat{x}_{f}) by element-wise product between the first denoising mask (532) and the far-end signal (310 s_{f}); and
determine the far-end noise signal estimate (334 \hat{η}_{f}) by subtracting the far-end speech signal estimate (332 \hat{x}_{f}) from the far-end signal (310 s_{f}).

5. An apparatus according to claim 2, wherein the determining of the near-end microphone speech signal estimate (336 \hat{x}_{fn}) and the near-end microphone noise signal estimate (338 \hat{η}_{fn}) further comprises use of a second trained source separation model (430b) or a second trained denoising model (530b).

6. An apparatus according to claim 5, wherein the second trained source separation model (430b) is a second trained source separation deep neural network (431b), and wherein the determining the near-end microphone speech signal estimate (336 \hat{x}_{fn}) and the near-end microphone noise signal estimate (338 \hat{η}_{fn}) further causes the apparatus to:
determine, based on the at least one near-end microphone signal (320 s_{fn}), using the second trained source separation deep neural network (431b), a second source separation mask (434);
determine the near-end microphone speech signal estimate (336 \hat{x}_{fn}) by element-wise product between the second source separation mask (434) and the at least one near-end microphone signal (320 s_{fn}); and
determine the near-end microphone noise signal estimate (338 \hat{η}_{fn}) by subtracting the near-end microphone speech signal estimate (336 \hat{x}_{fn}) from the at least one near-end microphone signal (320 s_{fn}).

7. An apparatus according to claim 6, wherein the second trained source separation deep neural network (431b) is the first trained source separation deep neural network (431a).

8. An apparatus according to claim 5, wherein the second trained denoising model (530b) is a second trained denoising deep neural network (531b), and wherein the determining the near-end microphone speech signal estimate (336 fn and the near-end microphone noise signal estimate (338 \hat{η}_{fn}) further causes the apparatus to:
determine, based on the at least one near-end microphone signal (320 s_{fn}), using the second trained denoising deep neural network (531b), a second denoising mask (534);
determine the near-end microphone speech signal estimate (336 \hat{x}_{fn}) by element-wise product between the second denoising mask (534) and the at least one near-end microphone signal (320 s_{fn}); and
determine the near-end microphone noise signal estimate (338 \hat{η}_{fn}) by subtracting the near-end microphone speech signal estimate (336 \hat{x}_{fn}) from the at least one near-end microphone signal (320 s_{fn}).

9. An apparatus according to claim 8, wherein the second trained denoising deep neural network (531b) is the first trained denoising deep neural network (531a).

10. An apparatus according to claim 1, wherein the determining the predicted near-end speech signal (342 \hat{x}ₙ) further comprises use of a first trained conditioned diarization model (440a), and wherein the determining the predicted near-end noise signal (344 \hat{η}ₙ) further comprises use of a second trained conditioned diarization model (440b).

11. An apparatus according to claim 10, wherein the first trained conditioned diarization model (440a) is a first trained conditioned diarization deep neural network (441a), and wherein the determining the predicted near-end speech signal (342 \hat{x}ₙ) further causes the apparatus to:
determine, based on the near-end microphone speech signal estimate (336 \hat{x}_{fn}) and the far-end speech signal estimate (332 \hat{x}_{f}), using the first trained conditioned diarization deep neural network (441a), a first diarization mask (442); and
determine the predicted near-end speech signal (342 \hat{x}ₙ) by an element-wise product between the first diarization mask (442) and the near-end microphone speech signal estimate (336 \hat{x}_{fn}).

12. An apparatus according to claim 10, wherein the second trained conditioned diarization model (440b) is a second trained conditioned diarization deep neural network (441b), and wherein the determining the predicted near-end noise signal (344 \hat{η}ₙ) further causes the apparatus to:
determine, based on the near-end microphone noise signal estimate (338 \hat{η}_{fn}) and the far-end noise signal estimate (334 \hat{η}_{f}), using the second trained conditioned diarization deep neural network (441b), a second diarization mask (444); and
determine the predicted near-end noise signal (344 \hat{η}ₙ) by an element-wise product between the second diarization mask (444) and the near-end microphone noise signal estimate (338 \hat{η}_{fn}).

13. An apparatus according to claim 12, wherein the second trained conditioned diarization deep neural network (441b) is the first trained conditioned diarization deep neural network (441a).

14. An apparatus according to claim 1, wherein the altered far-end signal (326 \tilde{s}_{f}) comprises the far-end signal (310 s_{f}) reproduced by at least one near-end speaker (350) and altered by near-end environment acoustics.

15. An apparatus according to claim 1, wherein the far-end signal (310 s_{f}) is captured by a far-end microphone (316).

16. A method comprising:
obtaining a far-end signal (310 s_{f}), the far-end signal (310 s_{f}) being based on at least one far-end speech source (312) and at least one far-end noise source (314);
obtaining at least one near-end microphone signal (320 s_{fn}) captured by one or more near-end microphones (328), the at least one near-end microphone signal (320 s_{fn}) being based on at least one near-end speech source (322), at least one near-end noise source (324), and an altered far-end signal (326 \tilde{s}_{f});
determining, based on at least the far-end signal (310 s_{f}), a far-end speech signal estimate (332 \hat{x}_{f}) and a far-end noise signal estimate (334 \hat{η}_{f});
determining, based on the at least one near-end microphone signal (320 s_{fn}), a near-end microphone speech signal estimate (336 \hat{x}_{fn}) and a near-end microphone noise signal estimate (338 \hat{η}_{fn});
determining, based on at least the far-end speech signal estimate (332 \hat{x}_{f}) and the near-end microphone speech signal estimate (336 \hat{x}_{fn}), a predicted near-end speech signal (342 \hat{x}n) by attenuating an impact of the at least one far-end speech source (312) from the near-end microphone speech signal estimate (336 \hat{x}_{fn});
determining, based on at least the far-end noise signal estimate (334 \hat{η}_{f}) and the near-end microphone noise signal estimate (338 \hat{η}_{fn}), a predicted near-end noise signal (344 \hat{η}ₙ) by attenuating an impact of the at least one far-end noise source (314) from the near-end microphone noise signal estimate (338 \hat{η}_{fn}); and
outputting at least the predicted near-end speech signal (342 \hat{x}ₙ) and predicted near-end noise signal (344 \hat{η}ₙ).

17. An apparatus according to claim 16, wherein determining the far-end speech signal estimate (332 \hat{x}_{f}) and the far-end noise signal estimate (334 \hat{η}_{f}) further comprises using of a first trained source separation model (430a) or a first trained denoising model (530a).

18. An apparatus according to claim 17, wherein the first trained source separation model (430a) is a first trained source separation deep neural network (431a), and wherein determining the far-end speech signal estimate (332 \hat{x}_{f}) and the far-end noise signal estimate (334 \hat{η}_{f}) further comprises:
determining, based on the far-end signal (310 s_{f}), using the first trained source separation deep neural network (431a), a first source separation mask (432);
determining the far-end speech signal estimate (332 \hat{x}_{f}) by element-wise product between the first source separation mask (432) and the far-end signal (310 s_{f}); and
determining the far-end noise signal estimate (334 \hat{η}_{f}) by subtracting the far-end speech signal estimate (332 \hat{x}_{f}) from the far-end signal (310 s_{f}).

19. An apparatus according to claim 17, wherein the first trained denoising model (530a) is a first trained denoising deep neural network (531a), and wherein determining the far-end speech signal estimate (332 \hat{x}_{f}) and the far-end noise signal estimate (334 \hat{η}_{f}) further comprises:
determining, based on the far-end signal (310 s_{f}), using the first trained denoising deep neural network (531a), a first denoising mask (532);
determining the far-end speech signal estimate (332 \hat{x}_{f}) by element-wise product between the first denoising mask (532) and the far-end signal (310 s_{f}); and
determining the far-end noise signal estimate (334 \hat{η}_{f}) by subtracting the far-end speech signal estimate (332 \hat{x}_{f}) from the far-end signal (310 s_{f}).

20. A non-transitory computer readable medium comprising instructions, when executed by an apparatus, cause the apparatus to perform at least the following:
obtaining a far-end signal (310 s_{f}), the far-end signal (310 s_{f}) being based on at least one far-end speech source (312) and at least one far-end noise source (314);
obtaining at least one near-end microphone signal (320 s_{fn}) captured by one or more near-end microphones (328), the at least one near-end microphone signal (320 s_{fn}) being based on at least one near-end speech source (322), at least one near-end noise source (324), and an altered far-end signal (326 \tilde{s}_{f});
determining, based on at least the far-end signal (310 s_{f}), a far-end speech signal estimate (332 \hat{x}_{f}) and a far-end noise signal estimate (334 \hat{η}_{f});
determining, based on the at least one near-end microphone signal (320 s_{fn}), a near-end microphone speech signal estimate (336 \hat{x}_{fn}) and a near-end microphone noise signal estimate (338 \hat{η}_{fn});
determining, based on at least the far-end speech signal estimate (332 \hat{x}_{f}) and the near-end microphone speech signal estimate (336 \hat{x}_{fn}), a predicted near-end speech signal (342 \hat{x}ₙ) by attenuating an impact of the at least one far-end speech source (312) from the near-end microphone speech signal estimate (336 \hat{x}_{fn});
determining, based on at least the far-end noise signal estimate (334 \hat{η}_{f}) and the near-end microphone noise signal estimate (338 \hat{η}_{fn}), a predicted near-end noise signal (344 \hat{η}ₙ) by attenuating an impact of the at least one far-end noise source (314) from the near-end microphone noise signal estimate (338 \hat{η}_{fn}); and
outputting at least the predicted near-end speech signal (342 \hat{x}ₙ) and predicted near-end noise signal (344 \hat{η}ₙ).
